(19) United States
(12) Patent Application Publication
(10) Pub. No.: US 2016/0146429 A1
(43) Pub. Date: May 26, 2016

(54) SIMULATION FLAME DEVICE

(71) Applicant: Zhejiang Fuerj Electric Science and Technology Co., Ltd., Cixi (CN)

(72) Inventor: JIANFU LUO, Cixi (CN)

(73) Assignee: Zhejiang Fuerj Electric Science and Technology Co., Ltd., Cixi (CN)

(21) Appl. No.: 14/675,459

(22) Filed: Mar. 31, 2015

(30) Foreign Application Priority Data
Nov. 24, 2014 (CN) 201420712820.9

(51) Int. Cl. F21V 7/04; F21S 10/04; F21V 3/04

(52) U.S. Cl. CPC F21V 7/04; F21V 3/0472; F21V 3/04; F21S 10/046; F21W 2121/00

(57) ABSTRACT

A simulation flame device, including a housing, a coated plate located a front portion of the housing, a light translucent plate with a multiple of irregular color lump distributions behind the coated plate, a reflecting light wheel device consisted of a multiple of polygon reflecting light wheels located after the translucent plate, a light source located below the light translucent plate, a carbon bed is set under and between the light translucent plate and the coated plate, the light from the light source is reflected by the reflecting light wheel device to project on and to pass through the light translucent plate then to project onto the coated plate, a simulation flame with three-dimensional as well as realistic and beautiful effect is formed.

### CROSS REFERENCE TO RELATED PATENT APPLICATION

The present application claims the priority of the Chinese patent applications No. CN 201420712820.9 filed on Nov. 24, 2014, which applications are incorporated herein by reference.

### FIELD of THE INVENTION

The present invention relates to the field of decoration, especially in a simulation flames.

### BACKGROUND OF THE INVENTION

The simulation flame device is widely applied in indoor furniture, usually connected with the electric power the carbon bed can present realistic charcoal effect, play a very good and beautiful decorative effect. However, the effect of the simulation single flame in prior art lacks diversification and realism, affecting the aesthetics and realism.

### SUMMARY OF THE INVENTION

In order to solve the technical problems mentioned above, the invention provides a flame with variety and more realistic simulation of flame.

The new technical solutions are as follows:

A simulation flame device, including a housing, a coated plate located a front portion of the housing, a light translucent plate with a multiple of irregular color lump distributions behind the coated plate, a reflecting light wheel device consisted of a multiple of polygon reflecting light wheels located after the translucent plate, a light source located below the light translucent plate, the light from the light source is reflected by the reflecting light wheel device to project on and to pass through the light translucent plate then to project onto the coated plate, a simulation flame with three-dimensional as well as realistic and beautiful effect is formed.

As a best embodiment, the light translucent plate is a transparent plastic plate or a transparent glass plate.

As another embodiment, the coated plate is a coated glass or a coated plastic plate.

As another embodiment, the reflecting light wheel device comprises a first polygon reflecting light wheel and a second polygon reflecting light wheel, the first and second polygon reflecting light wheels alternately provided in parallel, and the first and second polygon reflecting light wheels are mounted on a frame through a shaft at both ends, the radius of the first polygon reflecting light wheel is larger than the radius of the second polygon reflecting light wheel.

As another embodiment, a carbon bed is set under and between the light translucent plate and the coated plate, the carbon bed is a simulation carbon bed or simulation charcoal laying on a mounting plate.

As another embodiment, the simulation charcoal is a light-transmitting glass particles or light-transmitting plastic particles.

As another embodiment, the multiple of irregular color lump distributions of the light translucent plate are self-character of the light translucent plate or created by printing color lump distributions on the surface of the light translucent plate.

According to the technical solutions of present invention, the multiple of colors of the multiple of irregular color lump distributions determines the color of flame formed on the coating plate, the light transmittance of the multiple of irregular color lump distributions determines the brightness of the flame formed on the coated plates. The colors and brightness of flame being combined with a multilayer of light source, stepped projected onto the translucent plate and the carbon bed create a naturally twisted, dark with bright, vivid and beautiful, multi-dimensional simulation flame stepped on the coated board, it is very realistic, good for watch.

### BRIEF DESCRIPTION OF THE DRAWINGS

FIG. 1 is a schematic diagram of a structure of the simulation flame device;

FIG. 2 is a diagram of the carbon bed, the cover is removed;

FIG. 3 is a top plan view of FIG. 2;

FIG. 4 is a schematic diagram of a portion of reflecting light wheel device.

### DETAILED DESCRIPTION OF THE INVENTION

The accompanying drawings and the following embodiments further illustrate the invention.

### Embodiment 1

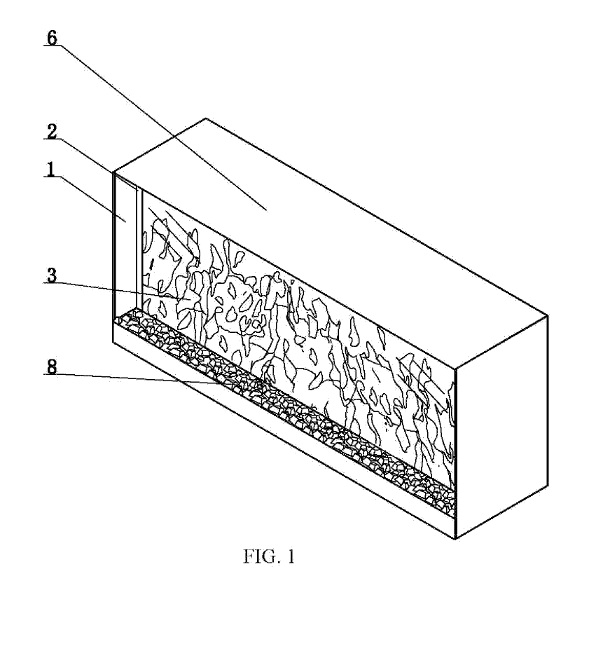

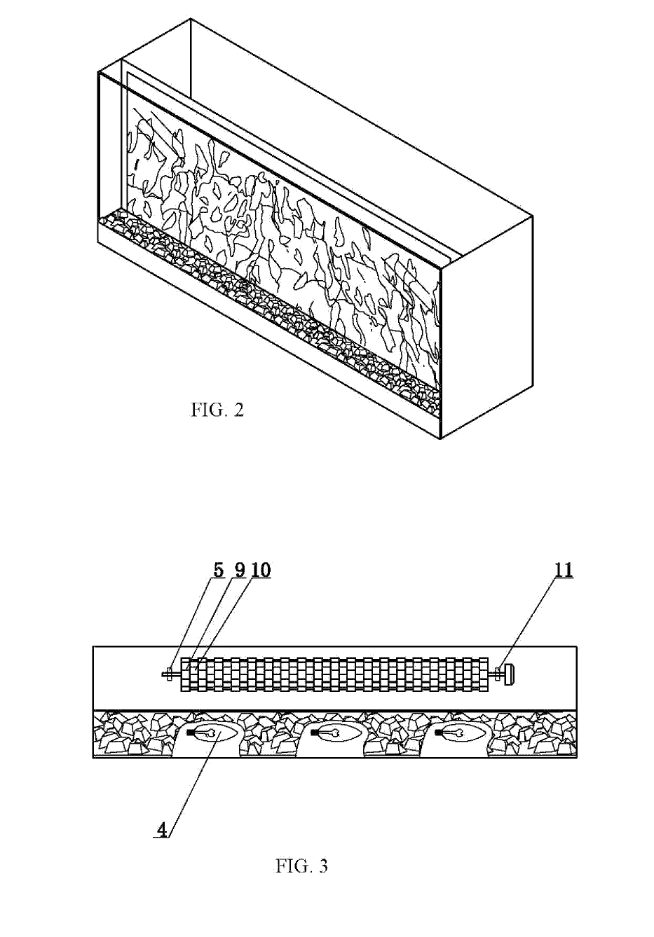

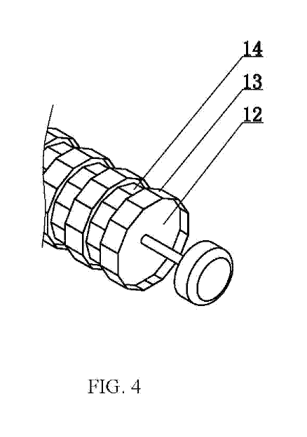

A simulation flame device as shown in FIGS. 1, 2, 3 and 4 includes a housing 6, the housing 6 has a rectangular parallelepiped type, the top cover of the housing 6 can be opened. The housing 6 has a coated plate 1 at front portion thereof. A light translucent plate 3 with a multiple of irregular color lump distributions is set behind the coated plate 1. The coated plate 1 is a coated glass. The light translucent plate is fixed by a fixing plate 2, the light translucent plate is a transparent glass with a multiple of irregular color lump distributions on the surface thereof. A reflecting light wheel device consisted of a multiple of polygon reflecting light wheels is set after the translucent plate. A light source 4 is set below the translucent plate. The light from the light source is reflected by the reflecting light wheel device to project on and to pass through the light translucent plate then to project onto the coated plate, a simulation flame with three-dimensional as well as realistic and beautiful effect is formed on the coated plate.

the reflecting light wheel device comprises a first polygon reflecting light wheel 9 and a second polygon reflecting light wheel 10, the first and second polygon reflecting light wheels 9, 10 alternately provided in parallel, and the first and second polygon reflecting light wheels 9, 10 are mounted on a frame 11 through a shaft at both ends, the radius of first polygon reflecting light wheel 9 is larger than the radius of second polygon reflecting light wheel 10, the polygon reflecting light wheel are made by stainless steel or other material with good reflecting ability. The first polygon reflecting light wheel 9 and the second polygon reflecting light wheel 10 have a certain angle of misalignment, so that the corresponding angles of the two polygon reflecting light wheels are not in a line, that increases diversity.

a carbon bed 8 is set under and between the light translucent plate 3 and the coated plate 1, the carbon bed 8 is a simulation carbon bed or simulation charcoal laying on a mounting plate, the simulation charcoal is a light-transmitting glass particles or light-transmitting plastic particles.

When used, the light source 4 located below the carbon bed 8 does not project to the light translucent plate directly, that brings a choice of a better visual effect. The radius of first polygon reflecting light wheel 9 is larger than the radius of second polygon reflecting light wheel 10, the first polygon reflecting light wheel 9 includes a first wheel body 12 and first wheel piece 13, the first wheel piece 13 is fixed on the first wheel body 12, the first wheel piece 13 is wider than the first body 12, thereby the first wheel piece 13 is reflected on the second wheel piece 14, both combine to project the light source onto the light translucent plate as multi points, continuous and stepped projection, a simulation flame with three-dimensional as well as realistic and beautiful effect is formed.

### Embodiment 2

This embodiment is the same as the embodiment 1 except that the light translucent plate 3 is made of a transparent plastic plate.

The above-described specific embodiments are exemplary only, in order to better enable those skilled people in the art to understand the present patent, they cannot be construed as limiting the scope of this patent; as long as is disclosed in accordance with the spirit of the present patent Any equivalent changes or modifications made, fall within the scope of this patent.

What is claimed is:

1. A simulation flames device comprising:
a housing;
a coated plate is set at a front portion of the housing,
a light translucent plate with a multiple of irregular color lump distributions is set behind the coated plate;
a reflecting light wheel device is set after the light translucent plate;
a light source is set below the light translucent plate;
light from the light source is reflected by the reflecting light wheel device to project on and to pass through the light translucent plate then to project onto the coated plate, a simulation flame with three-dimensional as well as realistic and beautiful effect is formed.

2. The simulation flames device of claim 1, wherein said light translucent plate is a transparent plastic plate or a transparent glass plate.

3. The simulation flames device of claim 1, wherein the coated plate is coated glass plate or coated plastic plate.

4. The simulation flames device of claim 1, wherein the reflecting light wheel device comprises a first polygon reflecting light wheel and a second polygon reflecting light wheel, the first and second polygon reflecting light wheels, alternately provided in parallel, and the first and second polygon reflecting light wheels are mounted on a frame through a shaft at both ends, the radius of first polygon reflecting light wheel is larger than the radius of second polygon reflecting light wheel.

5. The simulation flames device of claim 1, wherein a carbon bed is set under and between the light translucent plate and the coated plate, the carbon bed is a simulation carbon bed or simulation charcoal laying on a mounting plate.

6. The simulation flames device of claim 5, wherein the simulation charcoal is a light-transmitting glass particles or light-transmitting plastic particles.

7. The simulation flames device of claim 1, wherein the multiple of irregular color lump distributions of the light translucent plate are self-character of the light translucent plate or created by printing color lump distribution on the surface of the light translucent plate.
